(19) United States
(12) Patent Application Publication
(10) Pub. No.: US 2025/0032916 A1
(43) Pub. Date: Jan. 30, 2025

(54) METHOD AND DEVICE FOR RENDERING ENVIRONMENTS

(71) Applicant: ORANGE, Issy-les-Moulineaux (FR)

(72) Inventors: Riwan Majidate, CHATILLON CEDEX (FR); Nicolas Doisy, CHATILLON CEDEX (FR); Richard Guignon, CHATILLON CEDEX (FR)

(21) Appl. No.: 18/706,962

(22) PCT Filed: Nov. 3, 2022
(86) PCT No.: PCT/FR2022/052071

§ 371 Date: May 2, 2024

(30) Foreign Application Priority Data
Nov. 5, 2021 (FR) 2111769

(51) Int. Cl. A63F 13/52; A63F 13/428; G06T 15/20

(52) U.S. Cl. CPC A63F 13/52; A63F 13/428; G06T 15/20

(57) ABSTRACT

Method and device for rendering environments, in particular virtual environments. The device can include 2D and 3D rendering devices, such as virtual-reality headsets, holographic devices, etc. The method includes, when rendering a first environment: detecting parameters relating to an avatar, for rendering the first environment, the detecting being triggered by a command to move the avatar into a second environment, the detected rendering parameters are thus suitable for use in a first phase of rendering the second environment; and in the first phase of rendering the second environment, inserting a preview object containing the second environment into the first environment. Thus, when a second environment is rendered after rendition of the first environment, the user is not projected directly into the second environment. This decreases risk of motion sickness and fatigue due to leaps. Additionally, the user can anticipate the second environment, avoiding a risk of disorientation.

### CROSS-REFERENCE TO RELATED APPLICATIONS

This Application is a Section 371 National Stage Application of International Application No. PCT/FR2022/052071, filed Nov. 3, 2022, and published as WO 2023/079245 on May 11, 2023, not in English, which claims priority to French Application No. FR 2111769, filed Nov. 5, 2021, the contents of which are incorporated herein by reference in their entireties.

### TECHNICAL FIELD

The invention relates to a method and a device for reproducing environments, in particular virtual environments. An environment reproduction device is understood to include both 2D and 3D reproduction devices, such as virtual reality headsets, holographic devices, etc.

### PRIOR ART

The concept of reproducing environments was introduced above all with the emergence of virtual reality, made possible in particular by virtual reality headsets. These virtual reality headsets make it possible to reproduce either universes that are generated completely ab nihilo, also called a virtual environment, or remote places, also called remote real environment, in which the user has the impression of moving. These virtual reality headsets are therefore also called immersive devices. In order to enable this perception of immersion, virtual reality headsets generate an avatar of the user, of which the parameters in relation to their eyes will be based on the parameters of the user.

In most virtual reality experiences, virtual reality headsets enable the user to move in the environment reproduced by the headset with 3 or 6 degrees of freedom. However, the user wishing to move in these reproduced environments has a limited number of possibilities since only movement in their field of view is possible.

Either movements in this restricted area of the reproduced environment are triggered by manipulating a joystick (in particular by moving it). The avatar will then move in the gaze direction. The body of the user, for its part, remains static. This asymmetry between the avatar and its user, more precisely the asymmetry in terms of the virtual movement (movement in the virtual environment) and the immobility of the real user, generates motion sickness in some users.

Or movements are triggered by targeting the arrival point, also called raycast teleportation. The user navigates in the virtual environment (that is to say looks in the various directions of this virtual environment) to target their arrival area in their field of view and interacts therewith (by clicking on the targeted area, for example). Their avatar is then moved to this target point. The user has the impression of jumping forward in the reproduced environment. The jerky jumping effect may make navigation lengthy and repetitive if the user has to get to a distant area.

### SUMMARY OF THE INVENTION

One subject of the invention is an environment reproduction method comprising, during the reproduction of a first environment:
detection of reproduction parameters of the first environment relating to an avatar, triggered by a movement command to move the avatar to a second environment, the detected reproduction parameters being able to be used during a first phase of reproducing the second environment, and
during the first phase of reproducing the second environment, a preview inserting a preview object containing the second environment into the first environment.

Thus, during reproduction of a second environment after the reproduction of a first environment, the user is not projected directly into the second environment. This makes it possible to reduce the risks of motion sickness and fatigue associated with jumping. In addition, the user is then able to anticipate the second environment into which they will be projected, avoiding risks of disorientation.

It should be noted that the user has thus previewed the entire second environment as they will perceive it when they arrive in this second environment at the end of the first phase of reproducing the second environment, thus limiting risks of possible interaction errors in a partial preview of the second environment because the user does not anticipate interactions with the non-previewed part of the second environment.

Advantageously, the reproduction method comprises
reproduction of the first environment, and
after receiving a movement command to move the avatar placed in the first environment to the second environment, reproduction of the second environment, the reproduction of the second environment comprising a first phase and a second phase.

Advantageously, the reproduction method comprises a transition providing an intermediate environment between the first environment and the second environment to be reproduced during the first phase of reproducing the second environment.

Advantageously, the transition comprises a morphing.

Advantageously, the transition comprises the preview, and the preview inserts a preview object containing the second environment into the reproduction of the first environment.

Advantageously, a dimension of the preview object changes during the first phase starting from a default dimension value.

Advantageously, the change of the preview object results from a modification of the preview object on the basis of at least one interaction with the preview object.

The user thus controls the speed at which they integrate the second environment, further improving their acclimatization to this new environment.

Advantageously, the preview object is one of the following preview objects:
a plane,
a curved plane,
a volume.

Advantageously, the transition comprises a preview during a first period of the first phase of reproducing the second environment, and a morphing during a second period of the first phase of reproducing the second environment, the first phase of reproducing the second environment being formed successively of the first period and of the second period.

Advantageously, the morphing is triggered as soon as a preview object inserted into the first environment in which the preview reproduces the second environment reaches a maximum dimension.

Advantageously, the second environment contained in the preview object is a reproduction of the entire second environment or of the entire second environment that will be visible to the avatar when it arrives in the second environment at the end of the first phase of reproducing the second environment.

Advantageously, according to one implementation of the invention, the various steps of the method according to the invention are implemented by software or a computer program, this software comprising software instructions intended to be executed by a data processor of an environment reproduction device and being designed to command the execution of the various steps of this method.

The invention therefore also targets a program comprising program code instructions for executing the steps of the environment reproduction method when said program is executed by a processor.

This program may use any programming language, and take the form of source code, object code or intermediate code between source code and object code, such as in a partially compiled form or in any other desirable form.

Another subject of the invention is an environment reproduction device, the reproduction device comprising:
a detector for detecting reproduction parameters of the first environment relating to an avatar, triggered by a movement command to move the avatar to a second environment during the reproduction of a first environment, the detected reproduction parameters being able to be used during a first phase of reproducing the second environment, and
an environment inlayer, the environment inlayer being able, during the first phase of reproducing the second environment, to insert a preview object containing the second environment into the first environment.

### BRIEF DESCRIPTION OF THE DRAWINGS

The features and advantages of the invention will become more clearly apparent on reading the description, which is given by way of example, and the related figures, in which:

FIG. 1a shows a simplified diagram of the environment reproduction method according to the invention,

FIG. 1b shows a simplified diagram of the reproduction of the second environment implemented by the environment reproduction method according to the invention,

FIG. 2 shows a simplified diagram of the environment reproduction device according to the invention,

FIG. 3a shows a simplified diagram showing a reproduction of a first environment and of a second environment,

FIG. 3b shows a simplified diagram of a first variant of reproducing environments when an avatar moves from the first environment to the second environment of FIG. 3a according to the invention,

FIG. 4a shows a simplified diagram of a second variant of reproducing environments at the time of a movement request when an avatar moves from a first environment to a second environment according to the invention,

FIG. 4b shows a simplified diagram of a second variant of reproducing environments at the time following a movement request when the avatar of FIG. 4a moves from the first environment to the second environment, the reproduction of environments comprising a preview of the second environment, according to the invention,

FIG. 4c shows a simplified diagram of a second variant of reproducing environments at the time of a first interaction with the preview object of the second environment when the avatar of FIG. 4a moves from the first environment to the second environment according to the invention,

FIG. 4d shows a simplified diagram of a second variant of reproducing environments at the time of a second interaction with the preview object of the second environment when the avatar of FIG. 4a moves from the first environment to the second environment according to the invention,

FIG. 4e shows a simplified diagram of a second variant of reproducing environments at the time of reaching the maximum dimension(s) of the preview object of the second environment when the avatar of FIG. 4a moves from the first environment to the second environment according to the invention,

FIG. 4f shows a simplified diagram of a second variant of reproducing environments at the time of arrival of the avatar of FIG. 4a in the second environment when the avatar moves from the first environment to the second environment according to the invention.

### DESCRIPTION OF THE EMBODIMENTS

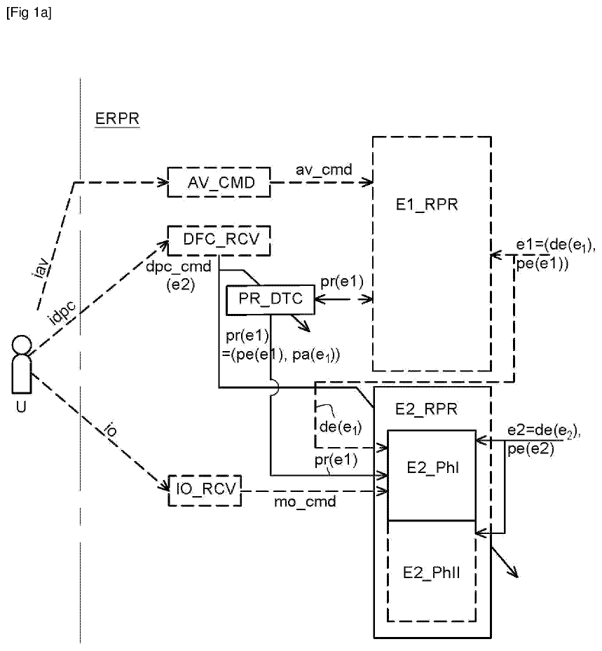

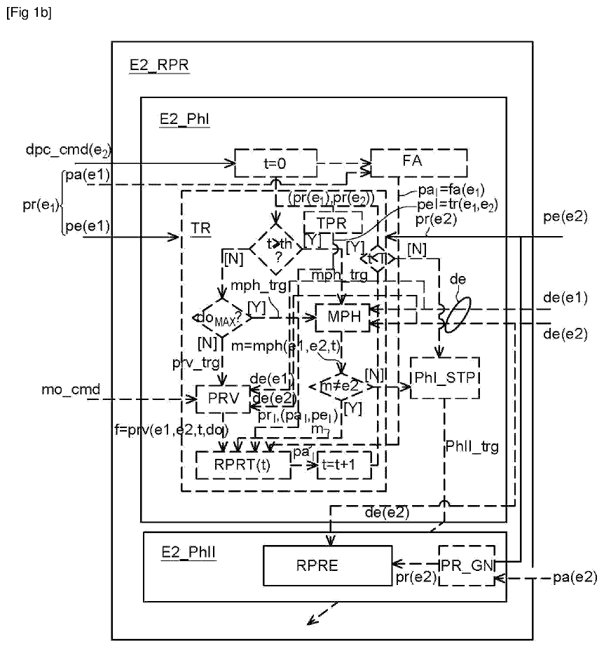

FIG. 1a illustrates a simplified diagram of the environment reproduction method according to the invention.

The environment reproduction method ERPR comprises, during the reproduction of a first environment E1_RPR:
detection PR_DTC of reproduction parameters of the first environment relating to an avatar pr(e1), triggered by a movement command to move the avatar to a second environment dpc_cmd(e2). The detected reproduction parameters pr(e1) are able to be used in a first phase of reproducing the second environment E2_PhI, and
during the first phase of reproducing the second environment, a preview PRV inserting a preview object OP containing the second environment E2 into the first environment E1.

The avatar constitutes a virtual representation of the user. In particular, the reproduced environment is the one seen by the avatar. Optionally, the hands of the avatar are reproduced in the environment, allowing the user to interact with objects in the environment (be this the first or the second environment, or even an intermediate environment).

In particular, the detection PR_DTC receives the reproduction parameters pr(e1) from the reproduction of the first environment E1_RPR. Optionally, following a request for the reproduction parameters pr_req (not illustrated) made by the detection PR_DTC to reproduce the first environment E1_RPR. As an alternative (not illustrated), the receipt of the movement command DPC_RCV triggers pr_trg the sending PR_SND, by the reproduction of the first environment E1_RPR, of the reproduction parameters of the first environment pr(e1) to the reproduction parameter detection PR_DTC.

The reproduction parameter detection is able to detect all parameters having a direct or indirect influence on the user in the virtual space, that is to say of the reproduced environment, in this case of the first environment, present at a given point, in this case at a first point of the first environment: sounds, brightness, 3D objects, gaze height, gaze orientation, etc.

In particular, the reproduction method ERPR comprises
reproduction of the first environment E1_RPR, and
after receiving a movement command to move the avatar placed in the first environment to the second environment dpc_cmd(e2), reproduction of the second environment E2_RPR.

The reproduction of the second environment E2_RPR comprises a first phase E2_PhI and a second phase E2_PhII.

Optionally, the movement command dpc_cmd(e2) specifies the second point of the second environment constituting the arrival point of the avatar in the second environment. The avatar is thus moved, teleported from the first point of the first environment at which it is positioned during the movement interaction idpc to the second point of the second environment.

In particular, the reproduction of an environment (first environment E1_RPR and/or second environment E2_RPR) receives components e1, e2 of the environment to be reproduced E1, E2. In particular, the components of the environment e1, e2 comprise data of the environment to be reproduced de(e1), de(e2) and reproduction parameters specific to an environment pe(e1), pe(e2).

In particular, the reproduction parameters specific to an environment pe(e1), pe(e2), also referred to as environmental parameters, are one or more of the following parameters:
noise level,
sound frequency,
tempo,
brightness,
colors,
shape,
etc.

In particular, the reproduction method ERPR comprises receiving AV_CMD an interaction iav of the user with an avatar during the reproduction of the first environment E1_RPR. With the avatar AV then being placed in the first environment E1, the interaction iav makes it possible to command the avatar av_cmd in order to interact with the first environment.

The commanding of the avatar av_cmd in particular modifies one or more reproduction parameters specific to the avatar in the environment pa(e1), also referred to as parameters of the avatar.

In particular, the parameters of the avatar pa(e1) are one or more of the following parameters:
gaze height hᵣ,
gaze orientation αᵣ.

In particular, the reproduction parameters of an environment pr(e1), pr(e2) comprise one or more reproduction parameters specific to an environment pe(e1), pe(e2) and/or one or more reproduction parameters specific to the avatar pa(e1), pa(e2).

In particular, the reproduction parameter detection PR_DTC provides reproduction parameters of the first environment pr(e1) to the reproduction of the second environment E2_RPR, in particular in its first phase E2_PhI.

In particular, the reproduction method EPRP comprises receiving DPC_CMD a movement interaction to move the avatar idpc to a second environment E2 distinct from the first environment E1. The receipt of the movement interaction DPC sends a movement command dpc_cmd(e2), which triggers the reproduction of the second environment E2_RPR and the detection PR_DTC of the reproduction parameters of the first environment currently being reproduced pr(e1).

FIG. 1b illustrates a simplified diagram of the reproduction of the second environment implemented by the environment reproduction method according to the invention.

In particular, the environment reproduction method ERPR comprises a transition TR between the reproduction of the first environment E1_RPR and the reproduction of the second environment itself during the second phase E2_PhII. In particular, the reproduction of the second environment E2_RPR comprises the transition TR during its first phase E2_PhI, the reproduction of the second environment E2_RPR starting at the time t=0. For example, the transition TR is implemented during a time period t=0 . . . T_{I}, T_{I} being the duration of the first phase of reproducing the second environment E2_PhI.

Optionally, the transition TR is triggered by a change of reproduced environment, for example by a movement command dpc_cmd(e2) to move to a second environment.

The transition TR is able to provide an intermediate environment E_{I} between the first environment E1 and the second environment E2. For example, this intermediate environment changes during the first phase of reproducing the second environment E2_PhI from an environment similar or identical (at least concerning one or more data and/or one or more environmental parameters) to the first environment E1 at the time t=0 to an environment similar or identical (at least concerning one or more data and/or one or more environmental parameters) to the second environment E2 at the time t=T_{I}.

In particular, the environment reproduction method ERPR comprises modifying avatar parameters FA, implemented in particular during the first phase of reproducing the second environment E2_PhI. In particular, the modification of avatar parameters FA modifies the parameters of the avatar pa_{I} upon entry t=0 into the second environment during the first phase E2_PhI, the reproduction of the second environment E2_RPR starting at the time t=0. For example, the modification FA is implemented during a time period t=0 . . . T_{I}, T_{I} being the duration of the first phase of reproducing the second environment E2_PhI.

Optionally, the modification of avatar parameters FA is triggered by a change of reproduced environment, for example by a movement command dpc_cmd(e2) to move to a second environment.

The user is thus not unbalanced when transitioning from the first to the second environment, thereby reducing the risks of motion sickness.

Upon entry into the second environment E2_PhI, t=0, the modified parameters of the avatar pa_{I} depend on the parameters of the avatar in the first environment pa(e1) upon receipt of the movement interaction DPC_RCV (cf. FIG. 1a): pa_{I}=fa(e1). The parameters of the avatar in the first environment pa(e1) upon receipt of the movement interaction are provided in particular by the reproduction parameter detection PR_DTC illustrated by FIG. 1a.

In particular, during the first phase of reproducing the second environment E2_PhI, the parameters of the avatar in the second environment pa_{I} are the same as the detected parameters of the avatar in the first environment pa(e1).

In particular, during the first phase of reproducing the second environment E2_PhI, the parameters of the avatar in the first environment pa(e1) are transposed accurately and in real time as parameters of the avatar in the second environment pa_{I}.

In particular, the transition TR comprises modifying FA avatar parameters.

In particular, the environment reproduction method ERPR comprises adapting reproduction parameters specific to an environment TPR implemented in particular during the first phase of reproducing the second environment E2_PhI. In particular, the adaptation of the reproduction parameters specific to an environment TPR adapts the reproduction parameters specific to an environment pe upon entry t=0 into the second environment during the first phase E2_PhI, the reproduction of the second environment E2_RPR starting at the time t=0. For example, the adaptation TPR is implemented during a time period t=0 . . . T_{I}, T_{I} being the duration of the first phase of reproducing the second environment E2_PhI. The adaptation TPR then provides intermediate environmental parameters pe_{I}.

Optionally, the adaptation of the reproduction parameters specific to an environment TPR is triggered by a change of reproduced environment, for example by a movement command dpc_cmd(e2) to move to a second environment.

The user is thus not disoriented during the transition from the first to the second environment, thereby reducing the risks of fatigue and therefore of interaction errors in the second environment.

The adapted reproduction parameters specific to an environment upon entry into the second environment or intermediate environmental parameters pe_{I} depend on the reproduction parameters specific to the first environment pe(e1) upon receipt of the movement interaction DPC_RCV (cf. FIG. 1a): pe_{I}=tr(e1). The reproduction parameters specific to the first environment pe(e1) upon receipt of the movement interaction are provided in particular by the reproduction parameter detection PR_DTC illustrated by FIG. 1a.

In particular, the adaptation of the reproduction parameters specific to an environment TPR implements a transition function tr for transitioning between the detected environmental parameters of the first environment pe(e1) and environmental parameters of the second environment pe(e2): pe_{I}=tr(e1,e2). Thus, during the first phase of reproducing the second environment E2_PhI, the intermediate environmental parameters pe_{I} are equal to the result of a transition function tr for transitioning between the detected environmental parameters of the first environment pe(e1) and environmental parameters of the second environment pe(e2): pe_{I}=tr(e1,e2). For example, the transition function tr is a line, an asymptote, etc. starting from the value of an environmental parameter of the first environment pe(e1) at the time t=0 of entry into the first phase of reproducing the second environment E2_PhI and arriving at the value of the same environmental parameter for the second environment pe(e2) at a time t at the latest equal to the duration of the first phase T_{I}.

The environmental parameters adapted to the entry into the second environment pe_{I} depend on the environmental parameters of the first environment pe(e1) upon receipt of the movement interaction DPC_RCV (cf. FIG. 1a): pe_{I}(t=0)=pe(e1). The environmental parameters of the first environment pe(e1) upon receipt of the movement interaction are provided in particular by the reproduction parameter detection PR_DTC illustrated by FIG. 1a.

In particular, the adaptation of environmental parameters TPR gradually transposes, over a predetermined period of time, for example a few seconds, the environmental parameters around the first point of the first environment pe(e1) and the second point of the second environment pe(e2).

In particular, the transition TR comprises adapting environmental parameters TPR.

The modification of the parameters of the avatar FA and/or the adaptation of the environmental parameters TPR thereby enables the avatar of the user to be moved, teleported while still maintaining the mobility of its gaze without the feeling of an abrupt teleportation, which is sometimes disconcerting and could be the cause of an interaction error in the second environment.

Therefore, if the user, by way of their avatar, changes from a quiet first environment to a very noisy second environment or from a dark first environment to a very bright second environment, the gradual transition provided by the modification of avatar parameters FA and/or the adaptation of the environmental parameters TPR makes it possible not to attack the user's senses and allows them to keep all their faculties of perception in the reproduced second environment, allowing them to interact quickly and appropriately.

In particular, the transition TR comprises a morphing MPH, also called morphosis. The morphing applies to visual data and/or audio data. In particular, the morphing MPH is applied between one or more objects to be reproduced in the first environment E1 and one or more objects to be reproduced in the second environment E2. For example, the morphing MPH is applied to one or more of the following objects to be reproduced:
objects to be reproduced at least one dimension of which is greater than a predetermined dimension, referred to as morphism dimension;
objects to be reproduced that are located in a central field of view of the avatar, the central field of view being defined by an angle less than a predetermined angle with respect to the orientation of the gaze of the avatar, also referred to as morphism angle;
objects to be reproduced of which the contrast with the background is greater than a predetermined contrast, referred to as morphism contrast;
an object to be reproduced constituting the background;
etc.

For example, the morphing MPH makes it possible to carry out a transition between a blue chair that becomes a red stool through continuous image transformation, between a yellow ambient light that becomes orange through continuous color transformation, a brick floor that becomes a marble floor through continuous texture transformation, but also rock music that becomes speech through continuous sound transformation, etc.

In particular, the transition TR comprises the preview PRV. The preview PRV inserts a preview object OP containing the second environment E2 into the first environment E1. The preview PRV thus provides an intermediate environment EI. The reproduction of the intermediate environment EI then makes it possible to inlay the reproduction of the second environment E2 in the reproduction of the environment E1 on a surface or a volume formed by the object O. A dimension dₒ of the object OP changes during the first phase E2_PhI starting from a default dimension value dₒ₀. For example, the change of the dimension of the preview object dₒ is a function of time t in the first phase E2_PhI: dₒ=e(t)×dₒ₀.

In particular, a change of a dimension of the preview object dₒ is understood to mean an increase in at least one dimension of the preview object (in our example, the evolution function e(t) is then an increasing function). A dimension of the preview object dₒ is a dimension of the plane of the preview object (for example, length, width, radius, etc.) when the preview object is two-dimensional, or the volume (for example, height, length, depth, radius, etc.) when the preview object is three-dimensional.

In particular, the change of the preview object e results from a modification of the preview object MO (not illustrated) on the basis of at least one interaction with the preview object io.

In particular, the user U may interact io, by way of the avatar AV, with the preview object OP on which the second environment E2 is reproduced by the preview PRV. In particular, the environment reproduction method comprises receiving the interaction with the preview object IO_RCV, as illustrated in FIG. 1a. The receipt of the interaction with the preview object IO_RCV then commands mo_cmd the preview PRV, in particular the modification of the preview object MO, so as to modify the preview object, in particular so as to change at least one dimension of the preview object OP.

In particular, the preview object OP is one of the following objects:
a plane,
a curved plane,
a volume.

In particular, the transition TR comprises a preview PRV during a first period t=[0,tb] of the first phase of reproducing the second environment E2_PhI, and a morphing MPH during a second period t=[tb,T_{I}] of the first phase of reproducing the second environment E2_PhI. The first phase of reproducing the second environment E2_PhI is formed successively of the first period t=[0,tb] and of the second period t=[tb,T_{I}].

Optionally, the transition TR triggers prv_trg the preview PRV of the second environment E2 at the start time t=0 of the first phase E2_PhI. Next, at each subsequent time t=t+1, the transition TR checks whether the current time t of the first phase E2_PhI corresponds to a time of the first or of the second period.

In particular, if the transition between the first and the second period is defined by a changeover time tb starting from which the first phase E2_PhI enters the second period, the check is performed by determining whether the current time is greater than or equal to this changeover time: t>tb?. If this is the case, the transition TR triggers mph_trg the morphing MPH, and if not the transition TR continues prv_trg the preview PRV.

For example, when the preview object OP is a 2D object or enables the second environment to be reproduced only in 2D, stopping the preview and changing to reproducing only the second environment in 3D (reproduction of the first environment stopped) corresponds to an impression of entering a cinema screen, in the poster for the user since the reproduction of the second environment changes from 2D to 3D (possibly using morphing to enable a smooth transition from planar reproduction to volume reproduction).

In particular, the morphing MPH is triggered mph_trg as soon as a preview object OP inserted into the first environment E1 in which the preview PRV reproduces the second environment E2 reaches a maximum dimension d_{oMAX}.

In particular, the transition TR provides environment data de and reproduction parameters pr to a reproduction of an intermediate environment RPRT(t). The environment data de_{I} and reproduction parameters pr_{I} provided by the transition TR consist in particular of one or more of the following data and/or parameters:
the result of the preview PRV: f=prv(e1,e2,t,do) comprising in particular environment data comprising some of the data of the first environment de(e1), data of the second environment de(e2);
the result of the morphing MPH: m=mph(e1,e2,t);
the intermediate parameters of the avatar pa_{I} resulting in particular from a modification of the avatar parameters FA: pa_{I}=fa(e1);
the intermediate environmental parameters, also referred to as reproduction parameters specific to an intermediate environment, pe_{I} resulting in particular from an adaptation of the reproduction parameters specific to an environment TPR: pe_{I}=tr(e1,e2);
the intermediate reproduction parameters prI comprising intermediate parameters of the avatar pa_{I} and reproduction parameters specific to an intermediate environment pe_{I};
etc.

In particular, the reproduction method comprises closing the first phase of reproducing the second environment PhI_STP, triggering the second phase E2_PhII. In particular, the first phase PhI_STP is closed at a time corresponding to one of the following times:
when the current time indicates that the duration of the first phase has been reached t<T_{I}=[N];
when the intermediate environment resulting from the morphing ei=m=mph(e1,e2,t) is the same as the second environment e2 (the morphing is complete);
more generally, when the transition TR is complete, in particular one or more of the following events has occurred:
when the intermediate reproduction parameters are the same as the reproduction parameters of the second environment (parameters of the avatar and/or environmental parameters);
when the preview is complete and does not trigger morphing, for example when one of the dimensions of the preview object reaches a maximum dimension;
when the morphing is complete, that is to say the result of the morphing m is the same as the second environment e2 (in particular, when the morphing concerns one or more objects to be reproduced, the object to be reproduced resulting from the morphing is the same as the corresponding object to be reproduced of the second environment).

Thus, with regard to its 3D or three-dimensional environment, in particular objects of the environment that the user sees around them through their avatar, the environment reproduction method, in particular the preview PRV and/or the morphing MPH, gradually erases the first environment, in particular seen from the first point, and replaces it with the reproduction of the second environment, in particular seen from the second point, possibly by making it appear gradually (in terms of size—preview—and/or in terms of transparency and/or shape—morphing).

In particular, the second phase of reproducing the second environment E2_PhII comprises reproducing the second environment itself RPRE on the basis of the environmental data of the second environment de(e2) and the reproduction parameters of the second environment pr(e2).

In particular, the second phase of reproducing the second environment E2_PhII comprises a reproduction parameter generator PR_GN providing the reproduction parameters of the second environment pr(e2). In particular, the reproduction parameter generator PR_GN retrieves the environmental parameters of the second environment pe(e2), in particular from an environment database or from an environment generation method (not illustrated). Optionally, the reproduction parameter generator PR_GN either retrieves the avatar parameters of the second environment pa(e2), for example from an avatar generation method for generating avatars in an environment (not illustrated), or computes them on the basis of the interaction of the user with the avatar relating to the second environment.

One particular embodiment of the environment reproduction method according to the invention is a program comprising program code instructions for executing the steps of the environment reproduction method when said program is executed by a processor.

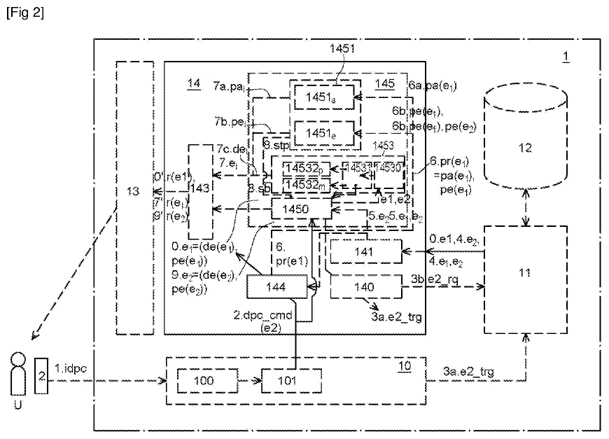

FIG. 2 illustrates a simplified diagram of the environment reproduction device according to the invention.

The environment reproduction device 14 comprises:
a detector 144 for detecting reproduction parameters of the first environment relating to an avatar, triggered by a movement command to move the avatar 2.dpc_cmd(e2) to a second environment during the reproduction of a first environment 0.r(e1). The detected reproduction parameters 6.pr(e1) are able to be used during a first phase of reproducing the second environment,
an environment inlayer 14532p, the environment inlayer 14532p being able, during the first phase of reproducing the second environment, to insert a preview object OP containing the second environment E2 into the first environment E1.

In particular, the movement command 2.dpc_cmd(e2) is provided by an input interface 10. The input interface 10 receives in particular an interaction of the user U, in particular a movement interaction to move in a second environment 1.idpc, for example from an interaction peripheral 2, such as a joystick or a remote control. In one particular embodiment of the input interface 10, the input interface 10 comprises an interaction receiver or sensor 100 receiving the interactions of the user. An interaction sensor 100 is in particular a camera, for example for gestural interaction, or a microphone, for example for interaction by voice command. Optionally, the input interface 10 comprises a command extractor 101. In particular, the command extractor 101 converts a received/captured interaction 1.idpc into a command 2.dpc_cmd(e2) or extracts a command 2.dpc_cmd(e2) from the received/captured interaction 1.idpc.

In particular, the environment reproduction device 14 comprises an environment receiver 141 receiving one or more environments 0.e1, 4.e2, 4.e1,e2. The environment receiver in particular receives one or more data de(e1), de(e2) and/or one or more environmental parameters pe(e1), pe(e2) relating to the corresponding environment. Optionally, the environment 0.e1, 4.e2, 4.e1,e2 is provided to the environment reproduction device 14 by an environment generator 11.

Depending on the modes of implementation, the environment generator 11 and the environment reproduction device 14 are implemented in an immersive device 1, or in distinct collocated devices, or even in distinct remote devices connected via a communication network. Optionally, the environment generator is an environment generation system comprising a generator for generating a first part of the environment 14, either implemented in an immersive device 1 with the environment reproduction device 14 or implemented in a device distinct from the environment reproduction device 14, and a generator for generating a second part of the environment, implemented in a device remote from the environment reproduction device 14, these being connected via a communication network.

In particular, the environment generator 11 generates or modifies an environment on the basis of previously recorded data, in particular previously recorded environments. In particular, the data and/or environments have been recorded beforehand in an environment base 12. In particular, the environment generator 11 generates or modifies an environment on the basis of avatar commands av_cmd coming for example from the input interface 10. Optionally, the input interface 10 directly triggers 3a.e2_trg the start of the provision of a second environment e2 by the environment generator 11 as soon as it receives a movement interaction to move to a second environment 1.idpc.

In particular, the environment generator 11 generates or modifies an environment on the basis of data captured in a real space remote from the user.

In particular, an environment requester 140 is triggered 3a.e2_trg upon receipt of the movement command 2.dpc_cmd(e2). The environment reproduction device 14 optionally comprises the environment requester 140. The environment requester 140 requests a particular environment, in particular from the environment generator 11, for example the second environment 3b.e2_trg when the environment requester 140 is triggered by the receipt of the movement command to move to the second environment 2.dpc_cmd(e2).

In particular, a reproduction signal generator 143 such as a reproduction card, in particular a video card and/or a sound card, etc. receives an environment to be reproduced 0.e1=(de(e1),pe(e1)), 7.e_{I}, 9.e2=(de(e2),pe(e2)), converts it into an environment reproduction signal 0′.r(e1), 7′.r(e_{I}), 9′.r(e2) and provides the signal to be reproduced to an output interface 13, that is to say an environment reproduction device, comprising in particular a virtual reality screen or screen system (glasses, virtual reality headsets), a holograph, a loudspeaker or a 3D loudspeaker system, etc. In particular, the environment reproduction device 14 comprises a reproduction signal generator 143.

In particular, an environment controller 145, also referred to as transition device for transitioning between a first environment and a second environment, is triggered by the movement command to move to the second environment 2.dpc_cmd(e2) during the reproduction of the first environment.

In particular, the environment controller 145 receives the reproduction parameters of the first environment 6.pr(e1) from the reproduction parameter detector 144.

In particular, the environment controller 145 receives at least one second environment 5.e2 in particular from an environment receiver 141, for example originating from an environment generator 11.

In particular, the environment controller 145 comprises an activator 1450 that activates one or more of the following devices of the environment controller 145:
a reproduction parameter controller 1451;
an avatar parameter modifier 1451a;
an environment parameter adapter 1451e;
an environment integrator 1453.

The activator 1450 activates at least one of the devices of the environment controller 145 upon receipt of the movement command 2.dpc(e2).

The reproduction parameters pr comprise in particular parameters of the avatar pa and environmental parameters pe. Therefore, the reproduction parameter detector 144 provides 6.pr(e1) parameters of the avatar in the first environment pa(e1) and environmental parameters of the first environment pe(e1).

In particular, the environment controller 145 modifies the avatar parameters of the second environment pa(e2) on the basis of the avatar parameters of the first environment pa(e1) and provides modified avatar parameters or avatar parameters of an intermediate environment 7b.pe_{I}.

The avatar parameters of the first environment result in particular from an interaction iav of the user with an avatar during the reproduction of the first environment 0′.r(e1). With the avatar AV then being placed in the first environment E1, the interaction iav makes it possible to command the avatar av_cmd in order to interact with the first environment E1. The commanding of the avatar av_cmd in particular modifies one or more reproduction parameters specific to the avatar in the environment pa(e1), also referred to as parameters of the avatar.

In particular, the parameters of the avatar pa(e1) are one or more of the following parameters:
gaze height hᵣ,
gaze orientation αᵣ.

In particular, the environment reproduction device 14 comprises an avatar parameter modifier 1451a that is active in particular during the first phase of reproducing the second environment E2_PhI (cf. FIGS. 1a, 1b). The avatar parameter modifier 1451a is optionally activated by the activator 1450. In particular, the avatar parameter modifier 1451a modifies the parameters of the avatar pa_{I} at the start of reproducing the second environment, corresponding to a first phase E2_PhI of reproducing the second environment.

In particular, the activator 1450 activates the modifier 1451a during a time period t=0 . . . T_{I}, T_{I} being the duration of the first phase of reproducing the second environment E2_PhI.

Optionally, the modifier 1451a is activated by the activator 1450 upon a change of reproduced environment, for example upon receipt of a movement command 2.dpc_cmd(e2) to move to a second environment.

For example, upon entry into the second environment E2_PhI, t=0, the modified parameters of the avatar 7a.pa_{I} provided by the modifier 1451a depend on the parameters of the avatar in the first environment 6a.pa(e1) upon receipt of the movement interaction 1.idpc: pa_{I}=fa(e1). The parameters of the avatar in the first environment 6a.pa(e1) upon receipt of the movement interaction are provided in particular by the reproduction parameter detector 144.

In particular, during the first phase of reproducing the second environment E2_PhI, the parameters of the avatar in the second environment 7a.pa_{I} are the same as the detected parameters of the avatar in the first environment pa(e1).

In particular, the environment controller 145 comprises the avatar parameter modifier 1451a.

In particular, the environment reproduction device 14 comprises an adapter for adapting reproduction parameters specific to an environment, also referred to as environmental parameter adapter, 1451e that is active in particular during the first phase of reproducing the second environment E2_PhI (cf. FIGS. 1a, 1b).

In particular, the reproduction parameters specific to an environment 6b.pe(e1), pe(e2), also referred to as environmental parameters, are in particular visual and/or audio parameters. These environmental parameters are in particular one or more of the following parameters:
noise level,
sound frequency,
tempo,
brightness,
colors,
shape,
etc.

The environmental parameter adapter 1451e is optionally activated by the activator 1450. In particular, the adapter for adapting reproduction parameters specific to an environment 1451e adapts the reproduction parameters specific to an environment pe at the start of the reproduction of the second environment, corresponding to a first phase E2_PhI of reproducing the second environment. The adapter 1451e then provides intermediate environmental parameters pe_{I}.

In particular, the activator 1450 activates the adapter 1451e during a time period t=0 . . . T_{I}, T_{I} being the duration of the first phase of reproducing the second environment E2_PhI.

Optionally, the environmental parameter adapter 1451e is activated by the activator 1450 upon a change of reproduced environment, for example upon receipt of a movement command 2.dpc_cmd(e2) to move to a second environment.

In particular, the adapted reproduction parameters specific to an environment upon entry into the second environment or intermediate environmental parameters 7b.pe_{I} depend on the reproduction parameters specific to the first environment 6b.pe(e1) upon receipt of the movement interaction 1.idpc: pe_{I}=tr(e1). The reproduction parameters specific to the first environment 6b.pe(e1) upon receipt of the movement interaction are provided in particular by the reproduction parameter detector 144.

In particular, the environmental parameter adapter 1451e computes the result of a transition function tr for transitioning between the detected environmental parameters of the first environment 6b.pe(e1) and environmental parameters of the second environment 6b.pe(e2): 7b.pe_{I}=tr(e1,e2). Thus, during the first phase of reproducing the second environment E2_PhI, the intermediate environmental parameters 7b.pe_{I} are the same as the result of a transition function tr for transitioning between the detected environmental parameters of the first environment 6b.pe(e1) and environmental parameters of the second environment 6b.pe(e2): pe_{I}=tr(e1,e2). For example, the transition function tr is a line, an asymptote, etc. starting from the value of an environmental parameter of the first environment pe(e1) at the time t=0 of entry into the first phase of reproducing the second environment E2_PhI and arriving at the value of the same environmental parameter for the second environment pe(e2) at a time t at the latest equal to the duration of the first phase T_{I}.

In particular, the environmental parameters adapted to the entry into the second environment 7b.pe_{I} depend on the environmental parameters of the first environment 6b.pe(e1) upon receipt of the movement interaction 1.idpc: pe_{I}(t=0)=pe(e1). The environmental parameters of the first environment 6b.pe(e1) upon receipt of the movement interaction 1.idpc are in particular provided by the reproduction parameter detector 144.

In particular, the environment controller 145 comprises the environmental parameter adapter 1451e.

In particular, the environment reproduction device 14 comprises a continuous media transformer 14532m. The continuous media transformer 14532m processes visual data and/or audio data, or even other types of data perceptible to the user (haptics, smell, etc.). In particular, the continuous media transformer 14532m performs a continuous transformation between one or more objects to be reproduced in the first environment E1 and one or more objects to be reproduced in the second environment E2. For example, the continuous media transformer 14532m is applied to one or more of the following objects to be reproduced:
objects to be reproduced at least one dimension of which is greater than a predetermined dimension, referred to as morphism dimension;
objects to be reproduced that are located in a central field of view of the avatar, the central field of view being defined by an angle less than a predetermined angle with respect to the orientation of the gaze of the avatar, also referred to as morphism angle;
objects to be reproduced of which the contrast with the background is greater than a predetermined contrast, referred to as morphism contrast;
an object to be reproduced constituting the background;
etc.

In particular, the continuous media transformer 14532m computes the result of a morphing applied between one or more objects to be reproduced of the first environment and one or more objects to be reproduced of the second environment.

In particular, the environment controller 145 comprises the continuous media transformer 14532m.

In particular, the environment inlayer 14532p provides an intermediate environment EI. In particular, the environment inlayer 14532p computes the intermediate environment as a result of a preview function of the second environment in an object inserted into the first environment. The reproduction of the intermediate environment EI then makes it possible to inlay the reproduction of the second environment E2 in the reproduction of the environment E1 on a surface or a volume formed by the object OP. Optionally, a dimension dₒ of the object OP changes during the first phase E2_PhI starting from a default dimension value dₒ₀. For example, the change of the dimension of the preview object dₒ is a function of time t in the first phase E2_PhI: dₒ=e(t)×dₒ₀.

In particular, a change of a dimension of the preview object dₒ is understood to mean an increase in at least one dimension of the preview object (in our example, the evolution function e(t) is then an increasing function). A dimension of the preview object dₒ is a dimension of the plane of the preview object (for example, length, width, radius, etc.) when the preview object is two-dimensional, or the volume (for example, height, length, depth, radius, etc.) when the preview object is three-dimensional.

In particular, the change of the preview object e results from a modification of the preview object implemented by the environment inlayer 14532p on the basis of an interaction with the preview object io possibly received via the input interface 10, which commands the modification of the preview object by the environment inlayer 14532p by way of a command to modify the preview object.

In particular, the user U may interact io, by way of the avatar AV, with the preview object OP on which the second environment E2 is reproduced by the preview PRV. The input interface 10 comprises in particular a receiver 100 for receiving the interaction with the preview object. The input interface 10 receiving the interaction with the preview object io then commands mo_cmd the environment inlayer, in particular a preview object modifier (not illustrated), to modify the preview object, in particular to change at least one dimension of the preview object OP.

In particular, the preview object OP is one of the following objects:
a plane,
a curved plane,
a volume.

In particular, the environment controller 145 comprises the environment inlayer 14532p.

In particular, the environment controller 145 comprises an environment integrator comprising a continuous media transformer 14532m and an environment inlayer 14532p.

In particular, the environment integrator 1453 comprises a checker 14530 for checking predetermined processing conditions. The checker 14530 checks predetermined processing conditions on the basis of one or more of the following data:
a changeover duration from a first predetermined processing device to a second predetermined processing device;
a maximum preview object dimension;
etc.

In particular, the first predetermined processing device is the environment inlayer 14532p and the second predetermined processing device is the continuous media transformer 14532m.

In particular, the environment integrator 1453 comprises a switch transmitting the first and the second environment to a processing device determined by the checker 14530. In particular, the processing device determined by the checker 14530 is one of the following devices:
a continuous media transformer 14532m;
an environment inlayer 14532p.

In particular, the environment integrator 1453 provides the first and the second environment to the environment inlayer 14532p during a first period t=[0,tb] of the first phase of reproducing the second environment E2_PhI, and to the continuous media transformer 1532m during a second period t=[tb,T_{I}] of the first phase of reproducing the second environment E2_PhI. The first phase of reproducing the second environment E2_PhI is formed successively of the first period t=[0,tb] and of the second period t=[tb,T_{I}].

Optionally, the environment integrator 1453, in particular the checker 14530, triggers prv_trg the previewing of the second environment E2 at the start time t=0 of the first phase E2_PhI, in particular by commanding the switch 14531 to transmit the first and the second environment to the environment inlayer 14532p. Next, at each subsequent time t=t+1, the environment integrator 1453, in particular the checker 14530, checks whether the current time t of the first phase E2_PhI corresponds to a time of the first or of the second period.

In particular, if the transition between the first and the second period is defined by a changeover time tb starting from which the first phase E2_PhI enters the second period, the check is performed by determining whether the current time is greater than or equal to this changeover time: t>tb?. If this is the case, the environment integrator 1453, in particular the checker 14530, triggers mph_trg the morphing, in particular by commanding the switch 14531 to transmit the first and the second environment no longer to the environment inlayer 14532p but to the continuous media transformer 14532m, and if not, the environment integrator 1453 continues the preview, that is to say the environment inlayer continues to receive the first and the second environment.

In particular, the continuous media transformer 14532m receives the first and the second environment as soon as a preview object OP inserted into the first environment E1 in which the environment inlayer 14532p reproduces the second environment E2 reaches a maximum dimension d_{oMAX}.

In particular, the environment controller 145 provides environment data de and reproduction parameters pr of an intermediate environment RPRT(t), in particular to a reproduction signal generator 143. The environment data de_{I} and reproduction parameters pr_{I} provided by the environment controller 145 consist in particular of one or more of the following data and/or parameters:
the intermediate environment data provided by the environment inlayer 14532p resulting from a preview of the second environment in the first environment: f=prv(e1,e2,t,do) comprising in particular environment data comprising some of the data of the first environment de(e1), data of the second environment de(e2);
data provided by the continuous media transformer 14532m resulting from a morphing between one or more objects to be reproduced of the first environment and of the second environment: m=mph(e1,e2,t);
the intermediate parameters of the avatar pa_{I} provided in particular by an avatar parameter modifier 1451a: pa_{I}=fa(e1);
the intermediate environmental parameters, also referred to as reproduction parameters specific to an intermediate environment, pe_{I} provided in particular by an adapter for adapting the reproduction parameters specific to an environment 1451e: pe_{I}=tr(e1,e2);
the intermediate reproduction parameters prI comprising intermediate parameters of the avatar pa_{I} and reproduction parameters specific to an intermediate environment pe_{I}, in particular provided by a reproduction parameter controller 1451;
etc.

In particular, the activator 1450 commands closure of the first phase of reproducing the second environment PhI_STP, triggering the second phase E2_PhII. Optionally, the activator comprises an end of transition checker (not illustrated) commanding the closure of the first phase on the basis of predetermined closure conditions. In particular, one closure condition is that the current time corresponds to one of the following times:
when the current time indicates that the duration of the first phase has been reached t<T_{I}=[N];
when the intermediate environment resulting from the morphing ei=m=mph(e1,e2,t) is the same as the second environment e2 (the morphing is complete);
more generally, when the transition TR is complete, in particular one or more of the following events has occurred:
when the intermediate reproduction parameters are the same as the reproduction parameters of the second environment (parameters of the avatar and/or environmental parameters);
when the preview is complete and does not trigger morphing, for example when one of the dimensions of the preview object reaches a maximum dimension;
when the morphing is complete, that is to say the result of the morphing m is the same as the second environment e2 (in particular, when the morphing concerns one or more objects to be reproduced, the object to be reproduced resulting from the morphing is the same as the corresponding object to be reproduced of the second environment).

The command to close the first phase of reproducing the second environment deactivates the environment controller 145 and stops the reception of the first environment by the reproduction device 14, in particular by asking the environment generator 11 to stop the generation of the first environment. The reproduction device 14 thus receives 4.e2 only the second environment and transmits it to the output interface without modification, possibly via the activator 1450 and/or the reproduction signal generator 143.

In particular, during the reproduction of the first environment prior to the movement command 2.dpc_cmd(e2) to move in the second environment, or even during the second phase of reproducing the second environment (cf. FIGS. 1a, 1b), the devices described above may be used, including at least one of the following devices:
an input interface 10;
an environment generator 11;
an environment base 12;
an output interface 13;
an environment receiver 141;
an environment requester 140;
a reproduction signal generator 143;
a transition activator for activating a transition from a first environment to a second environment;
an environment reproduction device 14.

For example, in a first step prior to the implementation of the invention, the user U starts the environment reproduction and requests the reproduction of a first environment e1, in particular by way of a start interaction in a first environment 00.istrt(e1). The input interface 10 will then provide a command 00′.strt(e1)_cmd to the environment reproduction device 14, which will trigger the reproduction of the first environment 0′.r(e1).

Then, optionally, upon triggering by the command 00′.strt(1)_cmd from the input interface, the environment receiver 141 will receive the first environment 0.e1. For example, the command 00′.strt(1)_cmd is transmitted directly by the input interface to the environment generator 11 upon receipt of a start interaction in a first environment 00.istrt(e1). The first environment 0.e1 is then optionally transmitted to the environment reproduction device 14 upon request from the first environment 00.e1_rq. The request from the first environment 00.e1_rq is in particular sent by the environment requester 140 when the environment requester 140 is triggered by the receipt of a command to start environment reproduction with the first environment 00′.strt(e1)_cmd.

In particular, the activator 1450 of the environment reproduction device that has not received a movement command will provide the received first environment 0.e1 to the reproduction signal generator 143, which will then send a reproduction signal for the first environment 0′.r(e1) to the output interface, thus leading to the reproduction of the first environment.

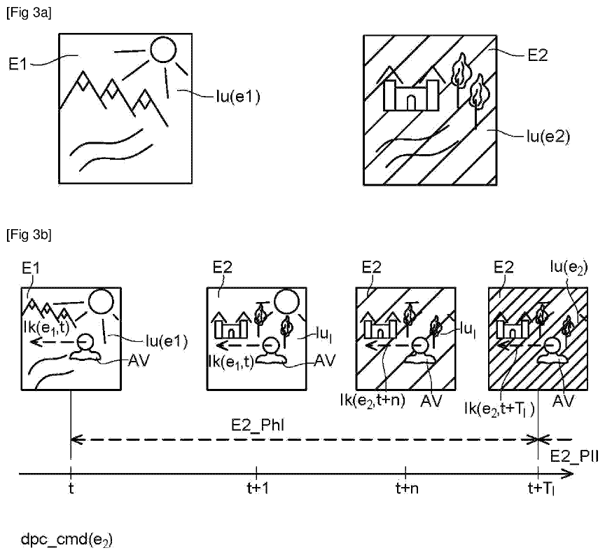

FIG. 3a illustrates a simplified diagram showing a reproduction of a first environment and of a second environment.

The first environment E1 illustrated by FIG. 3a is a bright environment. Conversely, the second environment E2 illustrated by FIG. 3a, to which the user requests to move, is a dark environment.

The brightness parameter forms part of the environmental parameters of the reproduction parameters. In the case of the first environment, the brightness parameter lu(e1) has a high value L. And, in the case of the first environment, the brightness parameter lu(e2) has a low value l or even a zero value (l=0). The large difference in brightness between the two environments may thus create discomfort, difficulty in adapting to the second environment for the user during the movement.

FIG. 3b illustrates a simplified diagram of a first variant of reproducing environments when an avatar AV moves the first environment to the second environment of FIG. 3a according to the invention.

The implementation of the invention should facilitate the transition from the first to the second environment illustrated by FIG. 3a.

While the first environment E1 is currently being reproduced with a high brightness lu(e1), for example lu(e1)=L, the gaze direction of the avatar in the first environment lk(e1) has a value lk(e1)=αᵣ.

At a time t, the user commands the movement from the first environment to a second environment dpc_cmd(e2).

The environment reproduction method according to the invention detects, upon receipt of the movement command dpc_cmd(e2), multiple reproduction parameters, in particular the brightness parameter lu(e1)=L and the gaze direction of the avatar lk(e1)=αᵣ.

The environment reproduction method modifies, at the following time t+1, the reproduction parameters of the second environment E2, in particular by modifying the brightness parameter lu(e2) and the gaze direction of the avatar on the basis of the detected reproduction parameters: brightness parameter lu(e1)=L and the gaze direction of the avatar lk(e1)=αᵣ.

The environment reproduction method then reproduces the environment E2 at the time t+1 with a brightness closer to that of the brightness of the first environment lu_{I}=tr(lu(e1)=l₁, l<l1<L, that is to say a relatively high brightness and an avatar whose gaze keeps the direction detected at the time t: lk(e2)=lk(e1,t)=αᵣ.

At another time t+n of the first phase of reproducing the second environment E2_PhI, the environment reproduction method modifies the reproduction parameters of the second environment E2, in particular by modifying the brightness parameter lu(e2).

The environment reproduction method then reproduces the environment E2 at the time t+n with a brightness that gradually moves away from that of the brightness of the first environment lu_{I}=tr(lu(e1))=lₙ, l<l₁<lₙ<L, that is to say a relatively lower brightness. On the other hand, the parameters of the avatar at the time t+n no longer depend on the parameters of the avatar in the first environment: for example, the gaze has a direction specific to the second environment: lk(e2,t+n).

At the end time of the first phase of reproducing the second environment E2_PhI and the beginning of the second phase of reproducing the second environment E2_PhII: t+T_{I}, the environment reproduction method uses the reproduction parameters of the second environment E2, in particular the brightness parameter lu(e2) and the gaze direction parameter of the avatar lk(e2,t+T_{I}).

Thus, not only is the user not destabilized by a sudden change of gaze orientation during the change of environment, but also the user does not encounter any problem of getting used to the new environment due to the gradual change in brightness. This makes it possible to reduce usage interaction errors in the second environment.

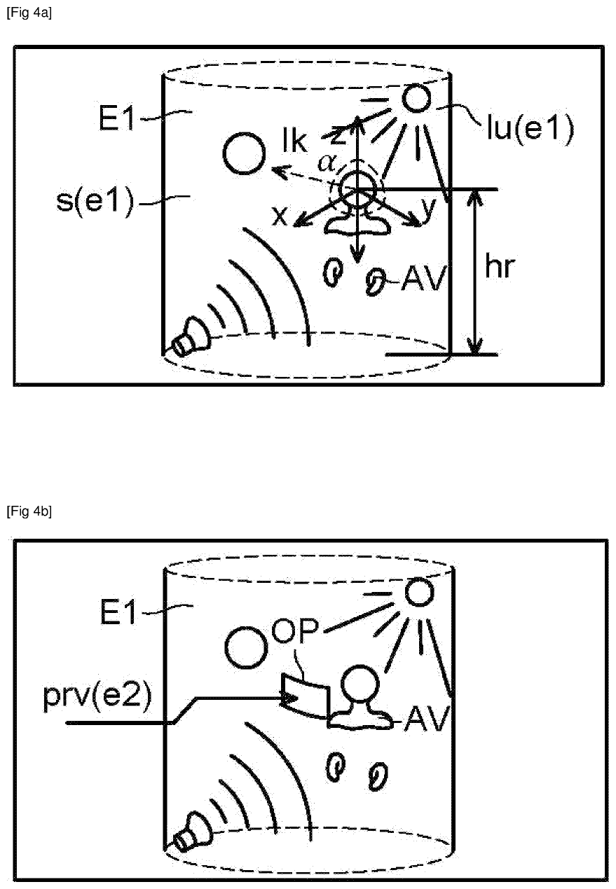

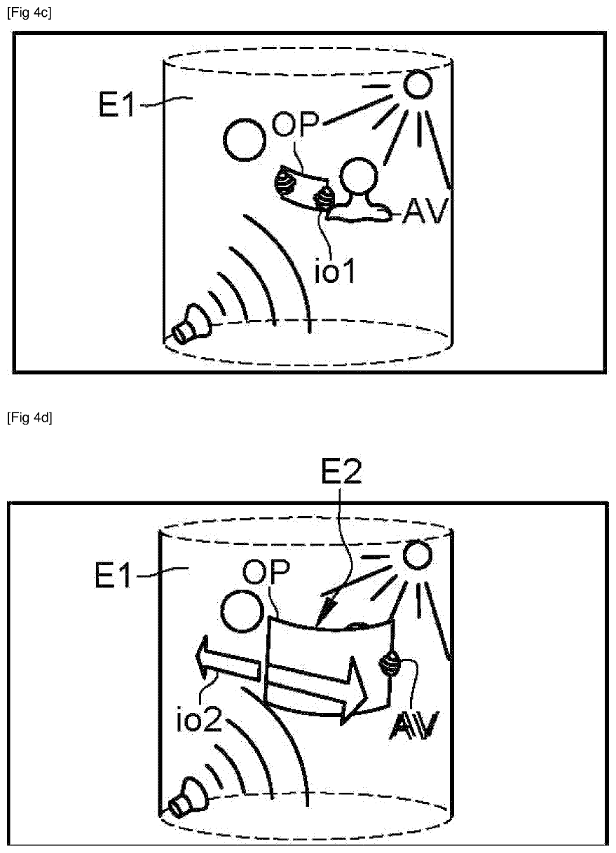

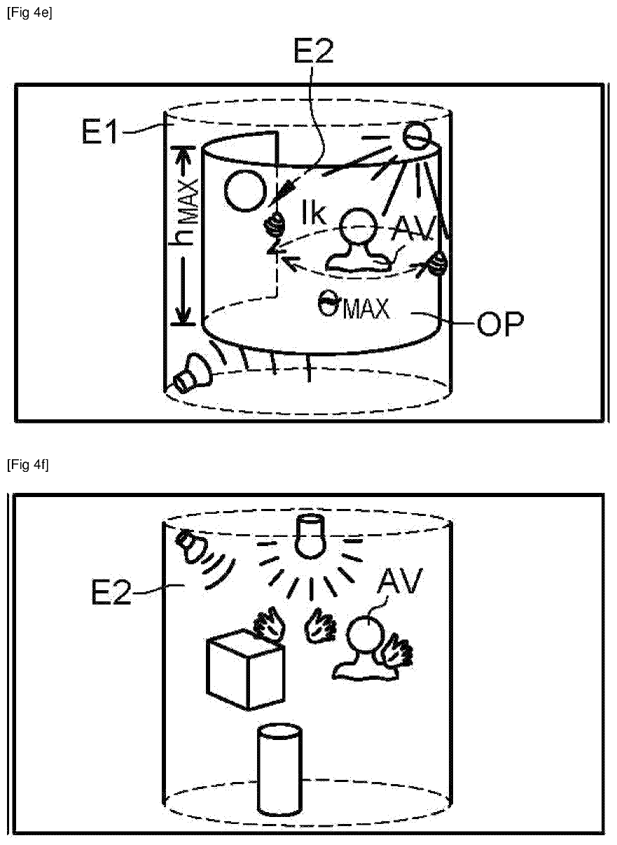

FIGS. 4a to 4f illustrate various times of a second variant of reproducing environments when an avatar moves from a first environment to a second environment according to the invention.

FIG. 4a illustrates the time t of the movement request dpc_cmd(e2) to move to a second environment E2.

The user U is in a first environment E1 with three-dimensional objects in their field of view, exposed to a sound s(e1) and a brightness lu(e1). The gaze of their avatar AV is positioned at a height hr and oriented at an angle αᵣ.

Let us take the example of Tom, the user U, immersed in a virtual reality concert experience. He is facing the stage when he receives a message from his friend Sarah in the lobby. He commands to be teleported to join his friend Sarah in the lobby, in particular by selecting the teleportation point of the lobby or even by simply commanding to join Sarah.

FIG. 4b illustrates, at the following time t+1, a movement request to move the avatar of FIG. 4a and an environment reproduction comprising a preview of the second environment.

At this time t+1, the environment reproduction method according to the invention illustrated by FIGS. 4a to 4f continues to reproduce the first environment E1, in which it inlays a reproduction of the second environment E2, in particular on an object OP, such as a surface, inserted into the reproduction of the first environment E1.

Thus, a preview of the second environment prv(e2) is displayed facing the avatar AV of the user, in particular from another viewpoint corresponding to a camera located in the second environment.

Furthermore, optionally, the environment reproduction method modifies the brightness parameter of the previewed second environment lu(e2) and/or the brightness parameter of the first environment. For example, if the first environment is brighter than the second environment lu(e1)>lu(e2), then, at this time, the environment reproduction method uses the same brightness parameter for the reproduction of the first environment E1 for the preview of the second environment prv(e2), the value of which, at this time, depends slightly on the brightness of these two environments E1, E2: lu_{I}=tr(e1,e2). In our example, the brightness lu_{I} at this time t+1 is slightly less bright than the brightness of the first environment lu(e1) in order to begin the transition with the brightness of the second environment lu(e2).

In particular, the surface of the preview object OP is a semi-transparent surface that makes it possible, to a greater or lesser extent, depending on the transparency parameter of the preview object, to glimpse the reproduction of the first environment E1 behind the preview of the second environment prv(e2) reproduced on the preview object OP inserted into the reproduction of the first environment E1.

In our example of Tom, at the time t+1 following the teleportation interaction, Tom previews, on the preview object OP (equivalent to a curved screen), the lobby and his friend Sarah. By virtue of the adaptation of the environmental parameters, the sound of the concert hall of the first environment still remains strongly audible to Tom, as though he were gradually moving away, and the brightness of the lobby is reduced as though the light of the lobby were perceived only through an open door in the concert hall.

FIG. 4c illustrates the time t+n1 of a first interaction io1 with the preview object OP of the second environment E2 when the avatar of FIG. 4a moves from the first environment to the second environment.

The environment reproduction method reproduces the interaction io1 of the avatar AV with the preview object OP following an interaction io of the user U commanding this interaction. In this case, the avatar grabs the surface constituting the preview object OP of the second environment E2.

At this time t+n1, the environment reproduction method continues to reproduce the first environment E1, in which it continues to inlay a reproduction of the second environment E2 in particular on the object OP, inserted into the reproduction of the first environment E1. Thus, at this time t+n1, the avatar AV of the user holds, in its hands, the preview object OP, on which the preview of the second environment prv(e2) is displayed facing said user.

Optionally, the environment reproduction method continues to modify the brightness parameter of the previewed second environment lu(e2) and/or the brightness parameter of the first environment. In our example, the brightness lu_{I} at this time t+n1 decreases further, and it is not only less bright than the brightness of the first environment lu(e1) but also than the brightness at the time t+1: lu_{I}(t+1) in order to continue the transition with the brightness of the second environment lu(e2).

In our example of Tom, at the time t+n1, Tom enlarges the preview screen OP (equivalent to a curved screen) on which the lobby and his friend Sarah, with which and whom he is already able to interact, are reproduced. Tom thus moves gradually from the concert hall to the lobby (the sound continuing to decrease and the brightness continuing to increase).

FIG. 4d illustrates the time t+n2 of a second interaction io2 with the preview object OP of the second environment E2.

The environment reproduction method reproduces the interaction io2 of the avatar AV with the preview object OP following an interaction io of the user U commanding this interaction. In this case, with the avatar having grabbed the surface constituting the preview object OP of the second environment E2 at a previous time t+n1, it extends the surface of the preview object OP. The surface of the preview object OP is a curved plane in our example. The extension io2 by the avatar AV of the preview object OP gradually superimposes, in its field of view, the preview of the second environment prv(e2) on an increasingly large portion of the reproduction of the first environment E1.

At this time t+n2, the environment reproduction method continues to reproduce the first environment E1, in which it continues to inlay a reproduction of the second environment E2 in particular on the object OP, inserted in enlarged form into the reproduction of the first environment E1. Thus, at this time t+n1, the avatar AV of the user continues to hold, in its hands, the enlarged preview object OP, on which the preview of the second environment prv(e2) is displayed facing said user.

Optionally, the environment reproduction method continues to modify the brightness parameter of the previewed second environment lu(e2) and/or the brightness parameter of the first environment. In our example, the brightness lu_{I} at this time t+n2 decreases further, and it is not only less bright than the brightness of the first environment lu(e1) but also than the brightness at the times t+1 and t+n1 in order to continue the transition with the brightness of the second environment lu(e2).

In our example of Tom, at the time t+n2, Tom continues to enlarge the preview screen OP (equivalent to a curved screen) on which the lobby and his friend Sarah, with which and whom he is already able to interact, are reproduced. Tom thus moves further away from the atmosphere of the concert hall to get closer to that of the lobby (the sound continuing to decrease and the brightness continuing to increase).

FIG. 4e illustrates the time tb of reaching the maximum dimension(s) d_{oMAX} of the preview object OP of the second environment.

At this time tb, the environment reproduction method continues to reproduce the interaction iob of the avatar AV with the preview object OP following an interaction io of the user U commanding this interaction. In this case, since the avatar AV continues to extend the surface constituting the preview object OP of the second environment E2 up to the maximum dimension d_{oMAX}, in particular a maximum height h_{MAX} and/or a maximum aperture angle θ_{MAX} of the curved surface, the environment reproduction method triggers the end of the preview.

The maximum dimension d_{oMAX} corresponds in particular to a dimension of the surface of the preview object OP such that the preview object OP superimposes, in its field of view, the preview of the second environment prv(e2) on a majority proportion of the reproduction of the first environment E1.

At this time tb, the environment reproduction method continues to reproduce the first environment E1, in which it continues to inlay a reproduction of the second environment E2 in particular on the object OP, inserted in enlarged form into the reproduction of the first environment E1. Thus, at this time tb, the avatar AV of the user continues to hold, in its hands, the enlarged preview object OP, on which the preview of the second environment prv(e2) is displayed facing said user.

Optionally, the environment reproduction method continues to modify the brightness parameter of the previewed second environment lu(e2) and/or the brightness parameter of the first environment. In our example, the brightness lu_{I} at this time tb decreases further, and it is not only less bright than the brightness of the first environment lu(e1) but also than the brightness at the times t+1, t+n1, t+n2 in order to continue the transition with the brightness of the second environment lu(e2), or it is even the same as the brightness of the second environment lu(e2).

When the preview object OP reaches a maximum dimension d_{oMAX}, the environment reproduction method stops the preview. Optionally, at this time tb, the environment reproduction method triggers a morphing between one or more objects to be reproduced of the first environment E1 and of the second environment E2. The environment reproduction method then carries out a gradual transition between elements having a direct or indirect impact on the user and their experience when the surface of the preview object reaches a maximum dimension d_{oMAX} corresponding for example to an almost full deployment of the surface of the preview object before the reproduction of the first environment (either the maximum height is close to the reproduction height of the first environment or the maximum angle is close to the reproduction angle of the first environment) (the reproduction angle of the first environment being equal to 360° in the case of a three-dimensional reproduction).

In our example of Tom, at the time tb, the preview screen OP having reached its maximum dimension, the reproduction method gradually fades out the crowd and the stage of the concert hall so as to substitute in objects in the lobby and Sarah, or even the preview screen OP, for example using morphing.

FIG. 4f illustrates the time of arrival of the avatar from FIG. 4a in the second environment when the avatar moves from the first environment to the second environment.

At the time TI, the environment reproduction method changes the reproduced environment and reproduces the second environment. Optionally, this time TI occurs when the morphing of FIG. 4e is complete or directly when the preview object has reached its maximum dimension.

For example, once the user, by way of an interaction with the preview object io, has commanded the avatar AV to stretch the preview object OP on which the second environment E2 is reproduced to the maximum extent D_{oMAX} and has maintained this position for a changeover duration Δ_{b}, in particular equal to two seconds, if the user commands the avatar AV to release the object, the environment reproduction method stops the preview and commands stopping of the reproduction of the first environment E1 and the reproduction of the second environment E2. The avatar AV is then moved, teleported into the second environment E2 that it was previewing.

In our example of Tom, at the time t+T_{I}, the reproduction method reproduces only the second environment, that is to say the lobby and Sarah, in particular seen from the second point. Tom is then teleported in full into the lobby.

Thus, by way of the environment reproduction method of the invention, Tom saw the first environment, the concert hall, gradually fade away (FIGS. 4b to 4e) and gradually be replaced (in particular by way of a preview, FIGS. 4b to 4d, and/or morphing, FIG. 4e) by the second environment, the lobby. The same possibly takes place for the loud volume emitted by the concert, which slowly returns to normal. The strong brightness of the lobby is for example also brought about gradually. This offers Tom a gentle transition. Tom was able to join Sarah quickly and without a sudden change in his experience that could have led to either interaction errors from Tom, or even Tom refusing to move and returning to the concert hall.

The invention also targets a medium. The information medium may be any entity or device capable of storing the program. For example, the medium may comprise a storage means, such as a ROM, for example a CD-ROM or a microelectronic circuit ROM, or else a magnetic storage means, for example a floppy disk or a hard disk.

Moreover, the information medium may be a transmissible medium such as an electrical or optical signal, which may be routed via an electrical or optical cable, by radio or by other means. The program according to the invention may in particular be downloaded from a network, and particularly from the Internet.

As an alternative, the information medium may be an integrated circuit into which the program is incorporated, the circuit being designed to execute or to be used in the execution of the method in question.

In another implementation, the invention is implemented by way of software and/or hardware components. With this in mind, the term module may correspond equally to a software component or to a hardware component. A software component corresponds to one or more computer programs, one or more subroutines of a program or, more generally, to any element of a program or of software that is able to implement a function or a set of functions in accordance with the above description. A hardware component corresponds to any element of a hardware assembly that is able to implement a function or a set of functions.

An exemplary embodiment of the present disclosure rectifies some drawbacks/deficiencies of the prior art/to make improvements to the prior art.

Although the present disclosure has been described with reference to one or more examples, workers skilled in the art will recognize that changes may be made in form and detail without departing from the scope of the disclosure and/or the appended claims.

1. An environment reproduction method implemented by a reproduction device and comprising, during reproduction of a first environment:
detecting reproduction parameters of the first environment relating to an avatar, triggered by a movement command to move the avatar to a second environment, the detected reproduction parameters being able to be used during a first phase of reproducing the second environment, and
during the first phase of reproducing the second environment, inserting a preview object containing the second environment into the first environment.

2. The environment reproduction method as claimed in claim 1, wherein the reproduction method comprises:
reproducing the first environment, and
after receiving the movement command to move the avatar placed in the first environment to the second environment, reproducing the second environment, the reproduction of the second environment comprising the first phase and a second phase.

3. The environment reproduction method as claimed in claim 1, wherein the reproduction method comprises generating a transition providing an intermediate environment between the first environment and the second environment to be reproduced during the first phase of reproducing the second environment.

4. The environment reproduction method as claimed in claim 3, wherein the transition comprises a morphing.

5. The environment reproduction method as claimed in claim 3, wherein the transition comprises the preview, and the preview inserts the preview object containing the second environment into the first environment.

6. The environment reproduction method as claimed in claim 1, wherein a dimension of the preview object changes during the first phase starting from a default dimension value.

7. The environment reproduction method as claimed in claim 6, wherein the change of the preview object results from a modification of the preview object on the basis of at least one interaction with the preview object.

8. The environment reproduction method as claimed in claim 1, wherein the preview object is one of the following preview objects:
a plane,
a curved plane,
a volume.

9. The environment reproduction method as claimed in claim 3, wherein the transition comprises a preview of the preview object during a first period of the first phase of reproducing the second environment, and a morphing during a second period of the first phase of reproducing the second environment, the first phase of reproducing the second environment being formed successively of the first period and of the second period.

10. The environment reproduction method as claimed in claim 9, wherein the morphing is triggered as soon as the preview object inserted into the first environment in which the preview reproduces the second environment reaches a maximum dimension.

11. The environment reproduction method as claimed in claim 1, wherein the second environment contained in the preview object is a reproduction of the entire second environment or of the entire second environment that will be visible to the avatar when it the avatar arrives in the second environment at an end of the first phase of reproducing the second environment.

12. A non-transitory computer readable medium comprising a program stored thereon comprising program code instructions for executing an environment reproduction method when said program is executed by a processor, wherein the method comprises, during reproduction of a first environment:
detecting reproduction parameters of the first environment relating to an avatar, triggered by a movement command to move the avatar to a second environment, the detected reproduction parameters being able to be used during a first phase of reproducing the second environment, and
during the first phase of reproducing the second environment, inserting a preview object containing the second environment into the first environment.

13. An environment reproduction device, the reproduction device comprising:
at least one processor;
at least one non-transitory computer readable medium comprising instructions stored thereon which when executed by the at least one processor configure the environment reproduction device to implement, during reproduction of a first environment:
detecting reproduction parameters of the first environment relating to an avatar, triggered by a movement command to move the avatar to a second environment during the reproduction of a first environment, the detected reproduction parameters being able to be used during a first phase of reproducing the second environment, and
during the first phase of reproducing the second environment, inserting a preview object containing the second environment into the first environment.
